(19) United States
(12) Patent Application Publication
(10) Pub. No.: US 2004/0233288 A1
(43) Pub. Date: Nov. 25, 2004

(54) Computer-aided system for image production

(76) Inventors: Mario Hytten, Selsey (GB); Karl Osen, Dardagny (CH)

Correspondence Address: HARNESS, DICKEY & PIERCE, P.L.C., P.O. BOX 8910, RESTON, VA, 20195, US

(21) Appl. No.: 10/860,289

(22) Filed: Jun. 4, 2004

Related U.S. Application Data
(63) Continuation-in-part of application No. PCT/IB02/01261, filed on Apr. 5, 2002.

(30) Foreign Application Priority Data
Dec. 4, 2001 (CH) CH 2212/01

(51) Int. Cl. G06K 9/00

(52) U.S. Cl. 348/159

(57) ABSTRACT

A system is for selecting filmed sequences acquired by several cameras pointing at fixed or mobile objects. The sequences are sent to a processing center. This processing center receives the data describing the behavior of the objects and affects the choice of sequences to be broadcast. Each camera takes sequences of which the positions in the visual environment are defined by captors measuring aiming angles and angles of view, which are transmitted to the processing center including a database qualifying the acquired sequences and enabling the creation of a sequence rating as a function of the portions of the visual environment which have been filmed and the behavioral data of the objects. Once this information has been processed by the processing center, the processing center has the means to select the sequence with the highest rating.

This application is a continuation-in-part of, and claims priority under 35 U.S.C. §120 and 35 U.S.C. §365(c) from, PCT International Application No. PCT/IB02/01261 which has an International filing date of Apr. 5, 2002, which designated the United States of America and which claims priority on Swiss Patent Application number CH 2212/01 filed Dec. 4, 2001, the entire contents of which are hereby incorporated herein by reference.

### FIELD OF THE INVENTION

The present invention generally concerns a device and process to produce, select and/or disseminate moving images or sequences filmed with a multitude of cameras. Such system is particularly useful for the production and dissemination of moving sequences for television, cinema or the internet.

### BACKGROUND ART

Current technology for the production and dissemination of sequences for television, cinema or internet would normally use several “cameras” in order to film “sequences” of “objects”.

“Camera” stands for a device equipped with one or several lenses and a device to capture the sequences.

“Sequence” stands for moving or still sequences collected by use of cameras from an <<event>>. The sequences can be fixed on photo-sensitive material (film) or on photo-sensitive electronics (sequence tube or several semi-conductor devices).

“Potential sequence” stands for the description of a scene including one or several “objects” that a camera could acquire if directed to do so.

“Object” stands for anything that can be of interest when viewed as part of a <<program>>, as the following but not limited to the following: a competitor, the start and finish line, the grandstands, an advertising hoarding, a rostrum.

<<Program>> stands for a television program, made up from a number of sequences selected and collated under the orders of the <<director>>. The program has the function of communicating to a homebound audience the most relevant, interesting and entertaining action of a sports <<event>>.

“Target” stands for the object and/or the objects that a “cameraman” or a filming system attempts to capture sequences of.

“Cameraman” stands for a person operating a camera.

“Event” stands for a televised sports event featuring one or several competitors.

Often the event to be broadcast includes several targets that shall be filmed by <<cameramen>> and/or the event may be taking place in an extended geographical area. The cameras used to televise such events are all connected to a central “production control room”, where the “director” selects the most appropriate sequence to be “broadcast”.

“Production control room” stands for the place where the director works. The production control room is equipped with a “wall of monitors”, recording equipment, audio equipment, etc.

“Director” stands for the person responsible for the television program and works from the aforementioned “production control room”. The director is seated in front of the wall of monitors displaying the sequences of all the filmed objects and selects the best sequences for inclusion in the “broadcast”.

“Broadcast” stands for the process of disseminating the television program from the production control room via wired and/or wireless transmitters, to be picked up by receivers at the consumer's end, which means that these are the television sequences that the audience can display on the television sets in their homes. The broadcast carries the sequence that has been selected by the director as the most desirable sequence at that time deriving from one of the cameras connected to the production control room.

For the avoidance of doubt, the term broadcast will also cover what is sometimes referred to as a “narrowcast”, namely a variation on the broadcast intended for a sub-set of the audience, such as the audience of a particular country, or the audience viewing the program on a specific type of platform that may not be a television set. The term “narrowcast” will be used when referring specifically to this type of dissemination.

“Wall of monitors” stands for a number of monitors installed on the wall facing the director's working place, enabling him to have an overview of the sequences deriving from all the cameras connected to the production control room.

“Monitor” stands for a screen displaying an sequence, usually a video sequence originating from a camera.

<<Arena>> stands for the geographical space in which the competitors perform, such as a football field, a racing track or the aerial space of an aerobatics competition.

The aforementioned director is connected via an audio link to each cameraman handling the cameras producing the sequences displayed on the wall of monitors. By pressing buttons, the director can select the sequences that he wishes to select for broadcast.

The director decides the target to be filmed at any one time and imparts the required orders via the audio link to the relevant cameraman, who tries his best to follow such orders.

This production method presents a number of problems. In particular the cameramen have limited information about the whereabouts of mobile objects until they appear in the viewfinder of the camera. This makes it difficult for them to react rapidly and precisely to the orders of the director. They also see a limited section of the arena and a small component of the overall action, reducing their ability to understand the relevance of the action taking place in their section of the arena to the overall physiognomy of the competition.

A large part of the finance for televised sports events is derived from sponsors (companies paying competitors to carry their logo), with the aim of exposing such logo to the audience of consumers watching that event on television. The amount of money paid for this type of advertising is becoming such a significant part of the overall finance for sports events that it is in the interests of all stakeholders involved in the sport, including the broadcasters themselves, to ensure that sponsors get value for money. Yet, the amount of visibility for logos on competitors involved in an event is severely limited by a cameraman's ability to follow the complex dynamics of a sports competitor in action. The problem is compounded by the fact that cameras cannot be placed too close to the action, obliging the use of long lenses which demand a level of precision and steadiness that is beyond the means of a human operator.

Another problem is that the cameraman is mainly restricted to the information he can glean from his viewfinder, and the director only sees what is conveyed on his monitors. Since it would be uneconomical to have one cameraman dedicated to each competitor in each event, this leads to the inevitable problem that many actions of interest may start to develop outside of the eyesight of both cameraman and director. It also means that when an action is spotted, the cameraman may need to re-assign his camera from a current filming routine to this new action, re-adjusting aiming angles, panning direction, zoom angle and focus.

For an action to be broadcast as it happens, there also needs to be communication between the cameraman and the director, or vice versa, to ensure that the right camera is filming the event and that the sequence from this camera is selected for broadcast at that time. Alternatively, the person in charge of recording the feed from alternate cameras must record from the appropriate camera at the right time. It is clear that this chain of events will take seconds, while the crucial part of the action itself may be over in a few tenths of a second. This leads to many situations where the most interesting action is not broadcast to the audience, or recorded, or indeed captured on camera.

The constant demand for more original viewing angles and the growing availability of specialty cameras means that the director must contend with an ever growing wall of monitors, decreasing the likelihood of him selecting the correct sequence at the right time.

Since the director selects the cameras on the basis of visual information only, it also means that every camera must be connected to the wall of monitors in the production control room at all times. This means that if carrying capability must be shared by several cameras on an alternate basis, for instance to share cable or wireless bandwidth, the director will temporarily lose the capability to interpret the importance of the sequences from those cameras.

### SUMMARY OF THE INVENTION

An embodiment of the invention aims to improve upon or even solve at least one of the problems described above by providing the director with a computer assisted production system.

In one embodiement of the invention, the camera mounts are equipped with <<pointing captors>>.

<<Pointing captors>> stands for a system using captors to detect the pan and tilt and roll angles, the field of view and the focal distance of a camera. This information describes what portion of the arena is being filmed and what field of view is being used.

In at least one embodiment of the invention, a computer contains one or several databases and uses the information from the pointing captors in order to describe the characteristics of potential sequences.

For a computer to assist a director in determining the most interesting potential sequences, three elements may be used:

the precise position at which each camera is pointing, the position of the objects and the parameters for evaluating the attractiveness of each potential sequence.

The databases loaded into the aforementioned computer might be databases concerning the objects, the cameras, the arena or generally any database on anything that might influence the interest of a potential sequence.

The database on the objects will contain any relevant information on any object that might be interesting to film at some point in the program. In such instances where the objects are moving, the data can be updated several times per second, using one or several <<positioning system(s)>>.

<<Positioning system(s)>> stands for any system capable of determining the position of an object in real time. One such system is described in patent application WO 98/19176 which describes a system tracking targets such as racing cars by cameras controlled by robots, the robots receiving positioning information from a central computer. The latter receives the accurate position of each object via global navigation system (GNSS) and sends orders to the robotic camera specifying aiming angles, field of view and focal distance.

Another method for determining position uses sensors placed in the ground and reacting to the passage of the objects. The central computer records the exact position upon passing the sensors and extrapolates the theoretical position in between sensors based on average speed and other relevant data, enabling the robotic camera to follow the object.

The data on each object may include, but is not restricted to, the following:

the position of the object (x, y, z),

speed of the object (vₓ, v_{y}, v_{z}),

acceleration of the object (aₓ, a_{y}, a_{z}),

orientation of the object (azimuth, pitch, roll),

speed or the orientation of the object (derived from orientation)

attitude speed (derivatives of attitude)

time since departure t₀

distance to target

estimated time of arrival tω

race classification

vehicle type

engine speed and gearbox setting

vibrations

max observation angle (maximum deviation from the front view which gives a satisfactory sequence)

viewing angle required for framing details such as the driver/rider, the cockpit, one of the wheels, the engine, the sails, the wings, lateral or frontal advertising positions, etc.

contractual obligations with advertisers (name, time, size).

The database does not only contain information regarding the objects, such as racing cars, but also information on the position of advertising hoardings, scoreboards, the VIP lodge and any other object which the director may define as a potential object of interest for inclusion in the program. The advertising spaces on a racing car can also be defined as objects, which means that one object can encapsulate several sub-objects. In order to accelerate calculations, objects can be treated as spheres, which we will name <<object spheres>>.

<<Object spheres>> stands for the sphere which completely encapsulates the object. For clarity, the position of the object can be given as the centre of the object sphere and the size of the object can be represented by the diameter of the sphere. The advantage of this representation is that, since the projection of a sphere is independent from its attitude (always a circle), the optimum viewing angle and the aiming angles required to frame the object correctly are easily calculated.

The system of an embodiment of the invention is based on the evaluation of each potential sequence, based on pre-determined criteria. The computer receives the data on the aiming angles of each camera from the pointing captors. It also receives the aformentioned parameters on the objects. Using the above data the computer generates a database of the sequences, where a large number of potential sequences are evaluated, listed, and sorted according to their <<sequence rating>>. The sequence rating indicates the estimated interest of the sequence for the program. The computer determines the best potential sequence as a function of the director's criteria which have been stored in the database.

<<Sequence rating>> stands for the numeric value calculated by the computer which corresponds to the interest of a potential sequence. The higher the sequence rating, the more interesting the potential sequence. The sequence rating therefore estimates the interest of a potential sequence, based on the criteria set by the director.

For example, a director will have the option to modulate his ratings as a function of the importance he gives to:

the position of the competitor in a competition

changes of position

closeness between several competitors

mechanical breakdowns and the nature of the mechanical breakdown

strategy, such as a pit-stop in a motor-race

incidents, such as a competitor deviating from the normal trajectory or even exiting the course, spinning or colliding with other objects including other competitors

etc.

The minimum sequence rating is zero. This may correspond to the given robot being unable to see a given object.

The following section rectifies the concept of the Unselect sequence, which does not make sense because in order to <<unselect>> you need to have a better sequence anyway (you can't unselect to nothing), so more relevant is how the machine decides that there is a better sequence available, not so much that the current sequence is not good enough.

<<Topsequence>> stands for the potential sequence with the highest sequence rating at any point during the event. The Topsequence may be used as the default sequence to be selected for the main broadcast unless the director overrides such selection. If the director prefers to keep more control of camera choice, the Topsequence may be used to sound an alarm to the director when it surpasses value X (<<Alarm Rating>>) or it may trigger a process that automatically overrides the director's original choice if it surpasses value Y (<<Override Rating>>). This would be triggered when the system detects the kind of events that usually develop too rapidly for the human reaction chain to cope with, such as accidents, or for sequences of such importance that they must not be missed under any circumstances, such as a change of lead, the winner crossing the finish line, etc.

The director will also set threshold values for the <<Backstop Rating>>. If all potential sequences fall below the Backstop Rating, the interest of the competition is temporarily so low that it may be difficult to maintain the interest of the wider television audience. This could trigger a routine whereby the computer temporarily splits the main broadcast into a number of narrowcasts, some of which may achieve a higher sequence rating than the Backstop Rating, in relation to certain sub-sets of the total audience. For instance, the system could produce a narrowcast for each national broadcaster featuring the best placed competitor from that nation. This is possibly more interesting to each national audience than, for instance, following the competitor that has lead unchallenged for a long period of the competition.

Narrowcasts to sub-sets of the audience may be produced for other reasons, for instance to disseminate the program to specific display platforms for which sequences must conform to special criteria, such as display platforms with limited bandwidth or a low resolution display screen.

The director can determine the pace and style of his program by modulating the time between camera cuts, the required sequence rating differential between sequences before a different routine is triggered, the time a routine is allowed to run or the sequence rating differential below which a routine is terminated and the system selects the feed from another camera. Each director can also modulate the individual sequence rating for each of the actions that the system is capable of detecting in an event, effectively imprinting his own style and feel to the program.

The director may prefer to retain manual control for sequence selection, maybe for a certain time-segment of the competition or in relation to a selection of competitors. In this case the system can be used to select a sub-set of the potential sequences to be displayed on the wall of monitors, so that the director can work with a manageable number potential sequences and therefore achieve better results.

Since the computer will also contain a calibrated three-dimensional model of the objects and the distance of each object the to each camera, the system will be able to determine at all times the field of view required in order to cover a certain portion of the screen, for instance for the target to fill the screen. This function is also useful in order to highlight one particular area of the object, the wheel on a racing car for instance.

In another embodiement of the invention the system uses <<robots>>, with the cameraman becoming a <<robot operator>>. The robot operator will use a computer interface to define the nature of the sequence he wants, including requirements of an artistic nature, as opposed to physically imprinting the motion to the camera.

<<Robot>> stands for the camera/lens complex being controlled by a motorized pan and tilt platform, allowing one or more of its functions to be remote controlled by an operator operating through a computer interface. In its ideal embodiment, the robot would allow the following functions to be operated remotely: focal distance, angle of view, rotations and translations of the motors.

<<Robot operator>> stands for a person operating a computer in order to define the characteristics of the sequence he desires to see on the screen. The robot operator would normally operate from within a production control room situated within the perimeter of the event. He can also operate more than one robot at a time.

The robot database contains information about the available robots, including but not limited to:

position (X, Y, X)

speed (Vx, Vy, Vz), for moving robots only.

acceleration (ax, ay, az), for moving robots only.

current aiming angles (indicating direction), left-right and up-down

maximum aiming angles

speed and maximum acceleration of the aiming angles

max pan and tilt speeds and accelerations.

current field-of-view

maximum and minimum field of view

current focal distance

maximum and minimum focal distance

The terrain database contains three dimensional descriptions of all fixed features of the area concerned by the filming mission, including:

topography

buildings

grandstands

towers

advertising panels

transparency of the ambient air (rain, fog, haze, pollution, turbulence, smoke). The database of the sequences is generated by the computer using the aforementioned databases.

In a system utilising robots, the sheer number of potential sequences becomes impossible for the director to manage: one camera could potentially film a close-up of abject A, or object B moving away from the camera, or object C moving closer to the camera or many other variations.

In the first embodiement of the invention, the camaraman chooses the most appropriate sequence on the basis of his intuition and experience. In the second embodiement of the invention, a large number of potential sequences are constantly being evaluated, listed and sorted as a function of their rating.

The participants in sports events are financed to a large degree by sponsorship. However, the unpredictability of sequence selections can produce disproportionately big discrepancies between the television coverage achieved for sponsors of equivalent importance, or between the sponsor's legitimate expectancy of coverage and the actual result.

The system of at least one embodiment of the invention can significantly improve the predictability of sponsorship coverage and the balance of coverage between sponsors of equivalent importance. This is due to the fact that the system's database can also be fed data based on the contractual arrangements with selected sponsors. The sequence rating of the logo for each selected sponsor would decrease with each second of measured visibility achieved during the program. The higher sequence rating for the remaining sponsors could trigger special instructions to the cameraman, or a modified set of orders to a robotic camera.

At the conclusion of the program, the central computer generates a report providing the time-code, the size and position of the logo on the screen, the duration during which the logo was visible on the screen and the quality of the visibility achieved (possibly degraded by angle or blur).

This report does not only count the selection made by the computer, but of the sequences that were actually broadcast. For instance, it is possible that the director overrides the selection proposed by the system. In this case, it is the data relative to the broadcast sequence that will be counted.

Each sequence will therefore be linked with the information on which objects are included in the sequence, their position, direction and dimension on the screen, their real-life speed, their position in relation to the arena and in relation other objects, the interest they represent in relation to the story of the event including race position, historic results, championship rank, nationality, prevailing atmospheric conditions. This information is stored with the sequences in order to assist with further use of the sequences which may include requests such as:

search <<car A>> and <<car B>> when <<car A>> is ahead of <<car B>>, size of <<car A>> is smaller than half the screen, for a duration of 4 seconds or more while advertising object C is visible.

Such sequences can be offered for sale, for instance on the internet. They can also be used in an edited version of the program for delayed broadcast.

Virtual sequences can be displayed on the monitors in some cases. Virtual sequences have several advantages:

a potential sequence can be displayed even if the associated robot is busy shooting something else.

a potential sequence can be displayed while the robot is busy rotating to get ready for that particular sequence.

a potential sequence can be displayed without requiring the full video bandwidth required to transport video from the associated robot. This is particularly important when the robots are connected to the production studio by radio (having limited bandwidth) or when the robots send sequences using the same network connection (also having limited bandwidth).

Another advantage of acquiring data and sequences simultaneously is the possibility to instantaneously attach such information to the sequence by way of on-screen graphics. This is particularly useful when the size (eg: helicopter image) or image quality (eg: in rainy conditions) makes it difficult to identify a competitor. The interest of a sequence would also be enhanced if it could display critical performance parameters such as race position, laps covered, distance between competitors, angle of drift in relation to the track, leaning angle for motorbikes or yachts, braking distance, etc.

### BRIEF DESCRIPTION OF THE DRAWINGS

Two embodiements of the invention will now be illustrated by the combination of its description and figures in which,

FIG. 1 describes the current typical technique of sequence acquisition at a sports event

FIG. 2 describes an embodiement of the invention where four robots are used to film an event

### DETAILED DESCRIPTION OF THE PREFERRED EMBODIMENTS

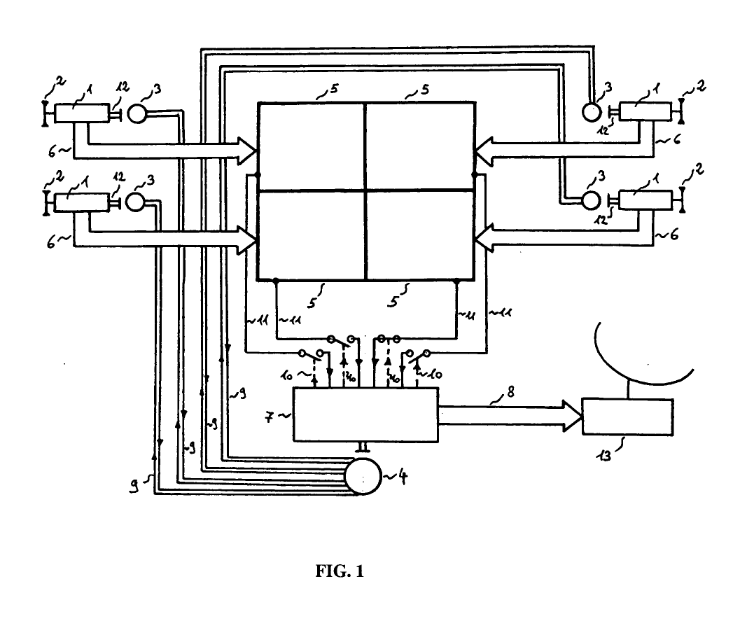

FIG. 1 shows a state of the art production control room, where television sequences are collected, selected and collated for broadcast. In this illustration the sequences are collected from four cameras 1 in order to obtain sequences of objects, not illustrated here because it is known art. Four cameramen 3 each manoeuver a camera 1, each of which includes a lens 2 and a manual control 12. The sequences 6 caught by cameramen 3 are transmitted to the production control room where they are displayed on monitors 5 forming the wall of monitors, each monitor 5 displaying the sequence by each camera 1.

Director 4 is seated in front of the wall of monitors 5, linked by audio 9 with the cameramen 3 who control the cameras 1. It is through audio link 9 that director 4 gives orders to cameramen 3 regarding which targets he wants to film, when and how. Director 4 uses a control system 7 with switches 10 which allow him to choose between sequences displayed on monitors 5, carried by cables 11 towards control system 7, the selected sequence 8 which he wants to transmit towards the broadcasting system 13 for dissemination to the television audience.

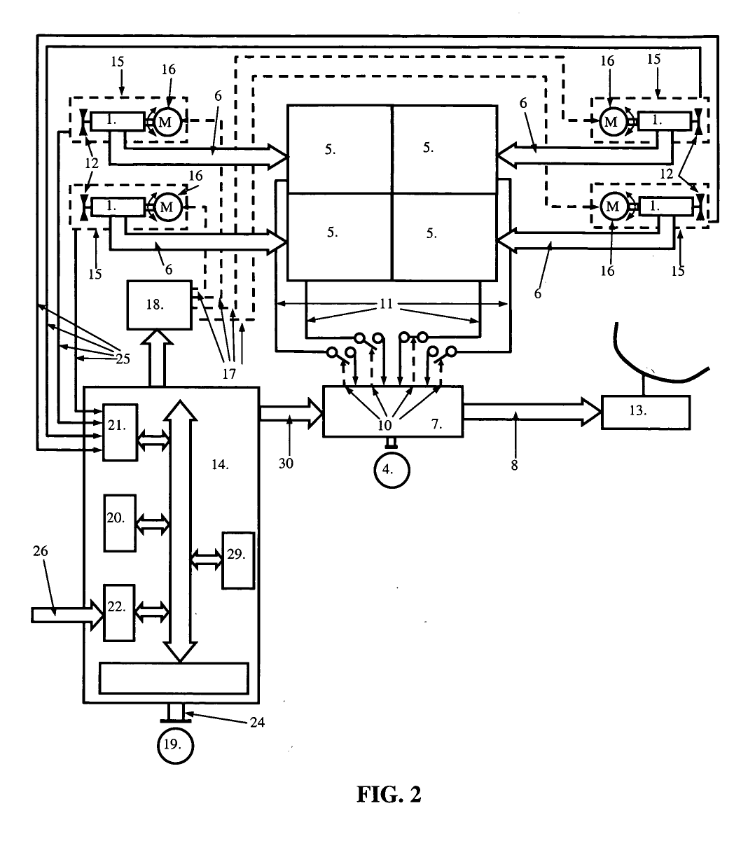

FIG. 2 shows the production control room in the second embodiement of the invention, where television sequences are collected, selected and collated for broadcast, with the assistance of computer 14, the sequences filmed with four robots 15. Each robot 15 includes a camera 1, at least one lens 12 and at least one pan and/or tilt motor 16. Each robot 15 is connected to computer 14 via a control system 17 and 18 which enable remote control of one or several elements of robot 15, for instance a motor 16 or the focal distance of lens 12.

In a first phase, the operator introduces stationary data 20 in computer 14, data on the objects 22, data on the robots 21, data on the topography of the arena, data on the position and characteristics of each robot, data on the potential sequences, data on the contractual arrangements in relation to the objects and data on the contractual arrangements in relation to the entity holding the television broadcast rights to the event.

Throughout the duration of the event to be filmed, the dynamic position data of the targets, the race positions, the atmospheric conditions, are transmitted 26 to computer 14 in the dynamic database 22.

For each camera, computer 14 evaluates and sorts by order of interest all the potential sequences against the evaluation criteria contained in databases 20, 21, 22 and 29. Additionally, computer 14 evaluates and sorts by order of interest all the potential sequences from all the cameras. If one camera tracks an object A for a sequence which at that point has the highest sequence rating, another camera capable of tracking object A may be instead be directed to track another object B in readiness for that object graduating to a higher sequence rating.

For instance, object database 22 is also fed with data 26 by one and/or several systems positioning determination systems, for instance GPS (Global Positioning System), not illustrated here because known art.

Robot database 21 is also fed data 25 by the measurement and/or communication systems that connect each robot 15 to computer 14.

Computer 14 generates a database of the targets 29 using the data contained in databases 20, 21, and 22. Target database 29 collects all potential sequences and their respective sequence ratings.

If sequence selection is performed automatically on the basis of the sequence rating, computer 4 transmits via communication system 30 to control system 7 the orders for this automatically selected sequence 8 to be transmitted to broadcasting system 13.

The system also facilitates interactive functions, for instance the ability to request information on a particular object appearing in the program. One of the simplest ways for the television viewer to identify the object he wants information on is by specifying the screen coordinates occupied by such object on a television screen, for instance by way of a pointing device similar to a computer mouse. An embodiment of the invention will allow to positively identify the object being pointed at, by correlating the above coordinates with the object that occupies those coordinates, extrapolating the information from the databases on the objects 22 and on the robots 21. This function will enable the broadcaster to trigger the correct interactive service.

Exemplary embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. Image acquisition and selection system comprising:
a plurality of cameras pointing at objects, with the resulting sequences being sent to a control center, the control center receiving data from which it derives the behavior of the objects and uses this information to select the sequence most appropriate for broadcasting, wherein each camera acquires sequences which are accurately positionable in relation to the visual environment by way of pointing and field of view captors whereof the data is sent back to the control center, which in turn contains a database containing data that allows to qualify and attribute a sequence index to both available sequences and potential sequences on the basis of the portion of the visual environment covered by the sequence and the behavior of the objects, the control center including means to select the sequence with the highest sequence rating.

2. Image acquisition and selection system according to claim 1, wherein the cameras are mounted on robots, the control center includes the means to control the robots as a function of the object's behavior.

3. Image acquisition and selection system according to claim 2, wherein the control center includes means to evaluate the potential sequences for each camera/robot unit as a function of the sequence ratings and the means to direct any such robot to acquire the potential sequence with the highest sequence rating.

4. Image acquisition and selection system according to claim 3, wherein the control center comprises the means to make a suitable composition of several objects into a new object when the distances between the objects are small and the sequence rating of this new object is higher than the sequence rating of any of the objects taken separately.

5. Image acquisition and selection system according to claim 1, wherein the control center comprises several databases with several sets of parameters for evaluating sequences, the control center has the ability to create and offer for dissemination a number of programs based on one or several sets of evaluation parameters.

6. Image acquisition and selection system according to claim 1, wherein the control center comprises means to determine and keep a historical log of the objects contained in the sequences that were selected for broadcast.

7. Image acquisition and selection system according to claim 6, wherein the quality parameters of the object are added to the historical log and include the time of broadcast, the size and the field of view of the object.

8. Image acquisition and selection system according to claim 6, wherein the control center comprises data on the amount of time an object has appeared in the broadcast and the control center reduces the sequence rating for that object once it has reached the desired amount.

9. Image acquisition and selection system according to claim 6, wherein the control center stores the sequences in conjunction with a description of the objects in the sequence and the dynamic parameters of the competition.

10. Image acquisition and selection system according to claim 1, wherein the control center inserts object identification information in the sequences.

11. Image acquisition and selection system according to claim 10, wherein the information comprises a name connected with the object, its position in the competition, its gap in relation to other competitors, information on the relative position and attitude of the object in relation to the arena.

12. Image acquisition and selection system according to claim 7, wherein the control center can respond to the request of identifying which object occupies given coordinates of a screen displaying the sequence.

13. Image acquisition and selection system according to claim 7, wherein the control center comprises data on the amount of time an object has appeared in the broadcast and the control center reduces the sequence rating for that object once it has reached the desired amount.

14. Image acquisition and selection system according to claim 7, wherein the control center stores the sequences in conjunction with a description of the objects in the sequence and the dynamic parameters of the competition.
